(19) United States
(12) Patent Application Publication
(10) Pub. No.: US 2022/0035170 A1
(43) Pub. Date: Feb. 3, 2022

(54) A VIRTUAL REALITY OR AUGMENTED REALITY HEADSET ACCESSORY

(71) Applicant: Eden Immersive Limited, Dublin (IE)

(72) Inventor: Rick TREWEEK, Johannesburg (ZA)

(73) Assignee: Eden Immersive Limited, Dublin (IE)

(21) Appl. No.: 17/311,190

(22) PCT Filed: Sep. 25, 2019
(86) PCT No.: PCT/IB2019/058144

§ 371 Date: Jun. 4, 2021

(30) Foreign Application Priority Data
Dec. 4, 2018 (ZA) 201808165

(51) Int. Cl. G02B 27/01

(52) U.S. Cl. CPC G02B 27/0176

(57) ABSTRACT

An accessory for a virtual reality or augmented reality headset. The accessory may include a means for attaching to the headset in a secure fashion and a handle extending from the means for attaching to the headset, in which means neither the means for attaching nor the handle (or a hand of a user) impedes the functionality of the headset (e.g., by blocking cameras, surface features, charging means, etc.).

### CROSS-REFERENCE TO RELATED APPLICATION

The application claims priority to South African Patent Application No. 2018/08165, filed 4 Dec. 2018, which is incorporated by reference in its entirety.

### FIELD OF THE INVENTION

The invention relates to accessories for a virtual reality or augmented reality headset.

### BACKGROUND

In recent years, the availability and functionality of virtual reality or augmented reality headsets has increased. This increase in availability and functionality has led to an increase in use of these devices. For example, while these devices were once limited to enclaves of video game providers and gaming communities, virtual reality or augmented reality headsets now have a wider following.

### SUMMARY

Despite a wider following, a staple of virtual reality or augmented reality has been ensuring an immersive experience. To ensure these immersive experiences, virtual reality or augmented reality headsets need to be both responsive to head movements and block out (to the extent possible) extraneous visual cues. To accomplish this, virtual reality headsets conventionally enclose both eyes of a user, so that only the screen generated by the virtual reality headset is viewable to the user. To ensure a proper fit, and support the weight of the headset, the headsets include straps or an adjustable rigid device that extends over the head of a user.

While straps are effective at supporting the weight of the headsets and enclosing the eyes of a user to create an immersive experience, strap mechanisms raise hygienic concerns when the headsets are shared among multiple users. This is particularly true of commercial uses of virtual reality or augmented reality headsets in which headsets may be used by numerous users, each for a brief time, and in a public setting. Due to the hygienic concerns, potential users may shy away from headsets that require a user to strap the headset to his or her head.

To overcome these issues, embodiments are disclosed herein for an accessory for a virtual reality or augmented reality headset that addresses one or more of the problems addressed above and below. Specifically, an accessory is described herein that includes an ergonomic handle accessory that addresses the issues particular to non-conventional support apparatuses for virtual reality or augmented reality headsets. For example, the sizes of virtual reality or augmented reality headsets are not standardized across the industry; therefore, each headset has particular dimensional requirements that must be addressed. The dimensions are particularly important to ensure that any accessory firmly and securely holds the headset to prevent the headset from falling while in use and/or to ensure that the user of the headset can maintain an enclosed, immersive experience while holding the headset.

Additionally, virtual reality or augmented reality headsets require large amounts of power. For commercial applications, even headsets with built in batteries will require periodic recharging. An accessory for a headset must therefore accommodate the various power supplies and recharging arrangements of various headsets. Furthermore, the headsets may require a user to initiate a recharge after a use in order to ensure that the headset is properly charged for the next user, the accessory needs to provide for a passive charging mechanism that users intuitively engage when completing their use of the headset.

Virtual reality or augmented reality headsets are also sensitive devices. The accessories (e.g., those featuring a handle mechanism) should ensure that when users return a device to an unused state that the users gently set the headset down. As the mass of the headset may be substantially more than the accessory (or a handle of the accessory), the accessory should therefore ensure that a user does not return the headset by swinging the headset down in a “head set first” arrangement that may cause the headset (and the sensitive components) inside to impact a table or other object upon which the headset rests.

Virtual reality or augmented reality headsets also often employ a plurality of externally facing cameras and sensors on the headset. These cameras and sensors are used to judge head movement of the user during virtual reality operations, view and track the environment in which the headset is being used, provide pass-through vision to the headset, and provide augmented reality functionality. Accessories for virtual reality or augmented reality headsets must therefore ensure that none of these cameras or sensors are blocked (either by the accessory or a hand of the user holding the accessory).

Finally, accessories for virtual reality or augmented reality headsets must provide a comfortable and ergonomic mechanism for holding the headsets as well as providing the user access to surface features on the headset (e.g., buttons, power outlets, volume and display controls, etc.). This mechanism should also support both right and left handedness of potential users and allow for operation of a control scheme (e.g., input controls built into the mechanism or designed to be used by a free hand of the user) by the user while interacting with the accessory.

In one aspect, the accessory is for a virtual reality or augmented reality headset. The accessory may include a means for attaching to the headset in a secure fashion and a handle extending from the means for attaching to the headset, in which means neither the means for attaching nor the handle (or a hand of a user) impedes the functionality of the headset (e.g., by blocking cameras, surface features, charging means, etc.).

In some embodiments, the accessory is for a virtual reality or augmented reality headset that has a proximal end through which a user views content while the headset is in use and a plurality of sides extending from the proximal end to a distal end. The accessory comprises a face plate removably attached to the headset at the distal end of the headset. The accessory also includes a flange extending from the face plate and configured to contact one or more of the plurality of sides of the headset to secure the face plate to the headset. The accessory also includes a handle extending, at a downward angle in the first direction, from a point substantially in line with a horizontal center point of the distal end of the headset.

Various other aspects, features, and advantages will be apparent through the detailed description and the drawings attached hereto. It is also to be understood that both the foregoing general description and the following detailed description are examples and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a sub-part of, or the entirety of, a given item unless the context clearly dictates otherwise.

### BRIEF DESCRIPTION OF THE DRAWINGS

FIG. 1 shows an accessory for a virtual reality or augmented reality headset currently engaged with the headset, in accordance with one or more embodiments.

FIG. 2 shows an accessory for a virtual reality or augmented reality headset, in which a handle extends from a flange, in accordance with one or more embodiments.

FIG. 3 shows an accessory for a virtual reality or augmented reality headset, in which a handle extends from a face plate, in accordance with one or more embodiments.

FIG. 4 shows an illustrative range of motion of a removable handle of an accessory

FIG. 5 shows an illustrative face plate, in accordance with one or more embodiments.

FIG. 6 shows another illustrative face plate, in accordance with one or more embodiments.

FIG. 7 shows another illustrative face plate, in accordance with one or more embodiments.

FIG. 8 shows an illustrative accessory with removable handle, in accordance with one or more embodiments.

FIG. 9 shows another view of an illustrative accessory with removable handle, in accordance with one or more embodiments.

FIG. 10 shows another view of an illustrative accessory with a removable handle engaged will the face plate, in accordance with one or more embodiments.

### DETAILED DESCRIPTION OF THE DRAWINGS

In the following description, for the purposes of explanation, numerous specific details are set forth in order to provide an understanding of example embodiments. It will be appreciated, however, by those having skill in the art that embodiments may be practiced without these specific details or with an equivalent arrangement.

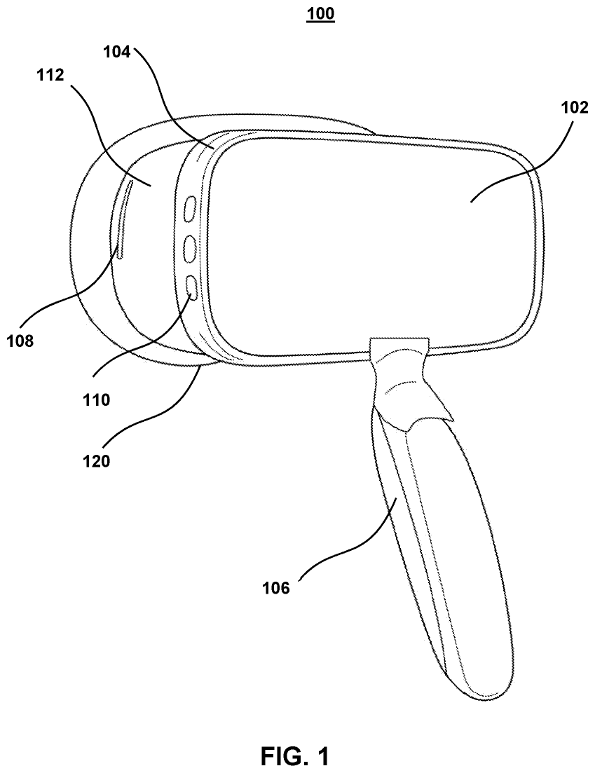

FIG. 1 shows an accessory for a virtual reality or augmented reality headset currently engaged with the headset, in accordance with one or more embodiments. For example, in FIG. 1, accessory 100 is currently engaged with virtual reality or augmented reality headset 120. Headset 120 is shown as a head mounted display device. It should be noted that in some embodiments, headset 120 may comprise a tablet computer, mobile phone, wearable electronic device (e.g., a watch, glasses, etc.), and/or other device through which a user may experience virtual reality and/or augmented reality.

As described herein, accessory 100 may engage with headset 120 through a variety of means. In some embodiments, accessory 100 may have a snap-fit connection with headset 120. The snap-fit connection may include annular, cantilever, u-shaped, bayonet-finger, and/or torsional snap-fit connections. For example, in an annular snap-fit, accessory 100 (e.g., flange 104) may experience a hoop-strain as its circumference is expanded as it is pushed onto headset 120. In another example, in a cantilever snap-fit, one or more protrusions of accessory 100 (e.g., located on flange 104) may hook into one or more recesses of headset 120. In another example, in a torsion snap-fit, one or more protrusions of accessory 100 (e.g., located on flange 104) are deflected away from a recess of headset 120. Upon releasing accessory 100 such that the one or more protrusions are no longer deflected away, headset 120 is held in place. It should be further noted that the snap-fit connections discussed above may be temporary or permanent. For example, the connections form between accessory 100 and headset 120 may require elastic or plastic deformations to connect or to be released.

The connections described above may involve one or more protrusions on accessory 100. These protrusions may be located on flange 104. Furthermore, the protrusions may interact with one or more recesses (e.g., recess 108) on headset 120. It should be noted that in some embodiments, accessory 100 may use natural recess or texture changes to connect with headset 120. For example, while in some embodiments, headset 120 may have been configured with recesses for receiving protrusions, in other embodiments, protrusions from accessory 100 may enter recess created for other functions. For example, as shown in FIG. 1, in some embodiments, recess 108 may represent a recess in headset 120 that may be used to string a head strap, a battery pack, a surface feature, and/or other design element on headset 120.

It should be noted that in some embodiments one or more of the elements discussed above may experience one or more of the connections discussed above on a portion or in a specific area of accessory 100. For example, headset 120 may have a proximal end through which a user views content during use. Headset 120 may also have a plurality of sides extending, in a first direction, from the proximal end to a distal end. In some embodiments, the headset may have, e.g., four sides (e.g., side 112), accessory 100 may connect (using a connection discussed above) to one or more sides. In some embodiments, accessory 100 may connect to headset 120 on all sides. In some embodiments, as shown in FIG. 1., accessory 100 may connect to headset 120 about the entire circumference of headset 120 (e.g., the circumference of headset about an axis along the first direction). In some embodiments, the connections between accessory 100 and headset 120 may be continuous (e.g., in an embodiment in which accessory 100 connects about the circumference of headset 120) or may be non-continuous (e.g., in embodiments of accessory 100 when face plate 102 includes one or more cut-out portions).

In some embodiments, accessory 100 may include one or more apertures in face plate 102 or flange 104. For example, as shown in FIG. 1, flange 104 includes aperture 110. In some embodiments, apertures in face plate 102 or flange 104 (e.g., aperture 110) may allow access to one or more surface features. As described herein, surface features may include any feature on the surface of headset 120. For example, a surface feature may include a button or other input mechanism and/or an I/O path (e.g., an HDMI, USB, etc. input). Additionally or alternatively, a surface feature may include a power supply (e.g., a port for inserting a power cable, connecting a battery, a copper pin connection) or an area used to connect to and/or facilitate a connection with an induction coil. Surface features may also include display areas (e.g., screens, digital displays, etc.) on the headset, speaker and/or audio ports, and/or camera lens or other sensors or content capture components. Surface features may also include design elements of headset 120 such as ridges, graphics, etc.

In some embodiments, one or more components of accessory 100, or the materials of those components, may be transparent or semi-transparent. In some embodiments, the use of transparent or semi-transparent materials may provide the same functionality of one or more apertures described herein. In some embodiments, apertures may include alternative materials than those used for non-apertures of accessory 100 (e.g., materials that allow surface features to be accessed). For example, through the use of transparent or semi-transparent materials and/or apertures, accessory 100 may prevent an obstruction of one or more cameras on headset 120.

Accessory 100 includes face plate 102. Face plate 102 is located at the distal end of headset 120. Face plate 102 is shown in FIG. 1 as comprising transparent or semi-transparent material. It should be noted that in some embodiments, face plate 102 may include one or more apertures to allow access to one or more surface features (e.g., a camera lens). Face plate 102 extends in a plane parallel to the distal end of headset 120. In some embodiments, face plate 102 may extend to the edges of the distal end of headset 120 in all directions. In some embodiments, face plate 102 may extend to only some of the edges of the distal end of headset 120. It should also be noted that in some embodiments, face plate 102 may only extend to some of the side (e.g., side 112) of headset 120. Furthermore, face plate 102 may extend in a non-uniform manner to one or more of the edges and/or one or more of the sides of headset 120.

In some embodiments, face plate 102 may comprise materials selected for a specific purpose. For example, in some embodiments, face plate 102 may comprise a metallic substance, an embedded metal substance, and/or other heat dissipating substance in order to dissipate heat from the distal end of headset 120. For example, a battery and/or main processor may be located at the distal end of headset 120. Accordingly, face plate 102 may comprise a material that is effective in dissipating this heat. In some embodiments, face plate 102 may include a material that allows graphics, branding, or other markings to be displayed.

Adjacent to face plate 102 is flange 104. Flange 104 may comprise a single flange that encircles the circumference of headset 120 or may include multiple flanges. For example, face plate 102 may include a separate flange for each side (e.g., side 112) of headset 120. It should be noted that in some embodiments, flange 104 (and/or face plate 102) may include one or more aperture and/or cut-out portions. It should be noted that a single flange with cut-out portions may be functionally equivalent to multiple flanges. It should therefore be noted that embodiments discussed herein with one flange (or a flange with a cut-out portion) also apply to embodiments with multiple flanges and vice versa.

Flange 104 may extend away from the plane of face plate 102 in a second direction that is opposite to the first direction. For example, flange 104 may extend over or on more of the sides (e.g., side 112) of headset 120. The extent to which flange 104 extends in the second direction may vary. For example, in some embodiments, flange 104 may extend in a second direction to a particular recess (e.g., recess 108). In some embodiments, flange 104 may extend in the second direction to a point in which a sufficient hoop-strain is exerted on flange 104 to hold accessory 100 to headset 120.

Flange 104 may include one or more protrusions. These protrusions may extend in towards headset 120. For example, the protrusions may be received by recesses (e.g., recess 108) in headset 120 in order to hold accessory 100 to headset 120. It should also be noted that in some embodiments, headset 120 may include protrusions that are received by recesses (or apertures) in accessory 100. For example, in some embodiments, headset 120 may include one or more protrusions, including a protrusion about the circumference of headset 120 that causes accessory 100 to be fitted to headset 120. For example, during connection flange 104 may be pushed over a protrusion on headset 120 to form a fitted connection.

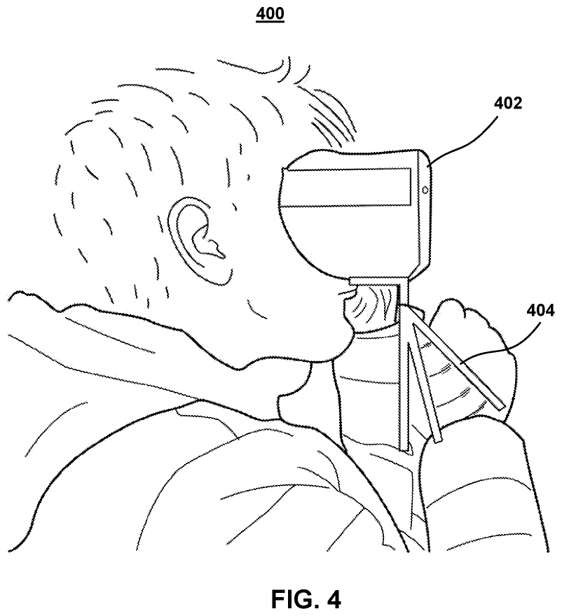

FIG. 1 also includes handle 106. As shown in FIG. 1, handle 106 connects to face plate 102. In some embodiments, handle 106 may connect to flange 104. In FIG. 1, handle 106 extends at a downward angle from accessory 100. The degree of the downward angle may vary (as described in relation to FIG. 4). In some embodiments, handle 106 may be removable. For example, handle 106 may connect to face plate 102 or flange 104 via one or more of the snap-fit connections discussed above. Additionally or alternatively, handle 106 may connect through other permanent or non-permanent mechanical fasteners. For example, handle 106 may connect via a thread fastener, clamp, buckle, or bolt. Furthermore, handle 106 may connect to accessory 100 through one or more joints to allow for a freedom of movement for handle 106. In some embodiments, handle 106 may also connect via a magnet system. For example, neodymium magnets may be placed at the base of handle 106 and/or the contact point on face plate 102 or flange 104.

Handle 106 is located near the bottom edge of face plate 102 and is located substantially in the horizontal center of the distal end of headset 120. For example, by placing handle 106 in this location, handle 106 as well the hand of a user holding headset 120 will not obstruct one or more cameras on headset 120. Furthermore, by placing handle 106 in this location, a left handed user or right handed user may grip handle 106 with his or her preferred hand. Moreover, as handle 106 extends in a downward angle in the first direction, handle 106 provides an ergonomic benefit, which may assist a user in holding headset 120 for the duration of his or her use.

As shown in FIG. 1, accessory 100 may be for a virtual reality or augmented reality headset (e.g., headset 120) having a proximal end through which a user views content while the headset is in use and a plurality of sides (e.g., side 112) extending from the proximal end to a distal end. Accessory 100 may include face plate 102, which is removably attached to headset 120 at the distal end of headset 120. Accessory 100 may also include flange 104 extending from face plate 102. Face plate 102 may be configured to contact one or more of the plurality of sides (e.g., side 112) of headset 120 to secure face plate 102 to headset 120. Accessory 100 may also include handle 106 extending, at a downward angle in the first direction, from a point substantially in line with a horizontal center point of the distal end of the headset 120. For example, by extending from a point in line with a horizontal center of the distal end of the headset, overall balance of the accessory 100 and headset 120 is improved.

For example, handle 106 may extend from a center point of face plate 102. This center point may be a center point in the vertical and/or horizontal direction. In some embodiments, handle 106 may extend from a point on face plate 102 that is centrally located in the horizontal direction, but substantially near the bottom edge of face plate 102 in order to ensure that handle 106 and/or a hand of a user does not obstruct a forward facing camera of headset 120. Furthermore, in some embodiments, handle 106 may extend from a flange 104, which extends along a bottom side of headset 120. Extending handle 106 from flange 104 (on the bottom side) further ensures that handle 106 and/or a hand of a user does not obstruct a forward-facing camera of headset 120. Furthermore, in some embodiments, extending handle 106 from a point away from the distal end, in a second direction, which is opposite of the first direction, may increase overall balance. For example, by moving the point at which handle 106 extends from accessory 100 closer to the proximal end also increases overall balance. Additionally or alternatively, handle 106 may extend towards a user. For example, handle 106 may extend in a downward angle in the second direction. In some embodiments, the direction of handle 106 may be based on the type of device of headset (e.g., head mounted display, tablet computer, etc.).

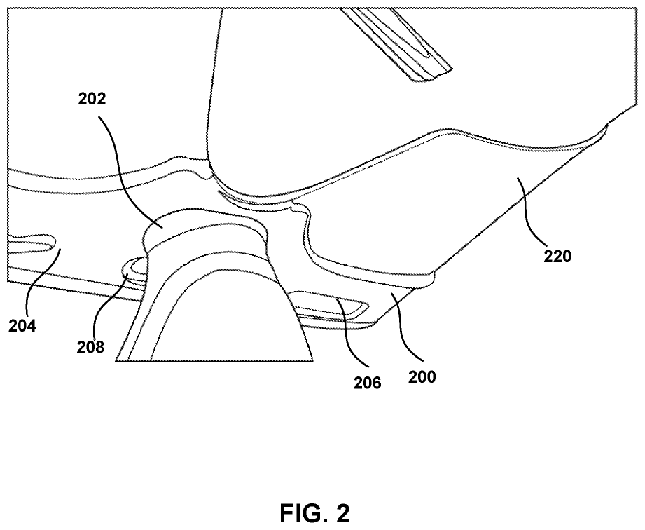

FIG. 2 shows an accessory for a virtual reality or augmented reality headset, in which a handle extends from a flange, in accordance with one or more embodiments. For example, FIG. 2 shows a bottom view of accessory 200 as it is engaged with headset 220. As shown in FIG. 2, flange 204 extends over a bottom side of headset 220. Additionally, flange 204 includes aperture 206, which may provide access to one of more surface features. Flange 204 also includes handle 202 extending from flange 204 in a first direction and at a downward angle.

FIG. 2 also includes I/O port 208. I/O port 208 may function as an inlet and/or I/O port. Furthermore, in some embodiments, I/O port 208 may facilitate power and/or data transfer between headset 220, accessory 200 (and/or components of accessory 200 such as a handle 202), and/or other components (e.g., a cradle or docking station for accessory 200). Additionally or alternatively I/O ports (e.g., I/O port 208) may allow cables and/or other object to leave/enter headset 220, accessory 200 (and/or components of accessory 200 such as a handle 202), and/or other components (e.g., a cradle or docking station for accessory 200).

I/O port 208 may provide access to one or more surface features, particularly those related to power supply. It should be noted that I/O port 208 may likewise function as an I/O port. Furthermore, I/O port 208 may provide electrical contacts and/or data transfer capabilities. For example, as headset 220 consumes power, headset 220 may need to be periodically recharged. I/O port 208 may provide this function. Moreover, as I/O port 208 is located adjacent to handle 206 and/or on the bottom of headset 220, I/O port 208 may connect to a cradle, stand, or other device to recharge while headset 220 is in non-use. For example, in some embodiments, during non-use headset 220 and accessory 200 may be place on a cradle or stand. The cradle or stand may include a power supply that may connect to I/O port 208 (or an electrical contact in I/O port 208), or in the case of a headset that uses an induction coil, facilitate the recharging via the coil.

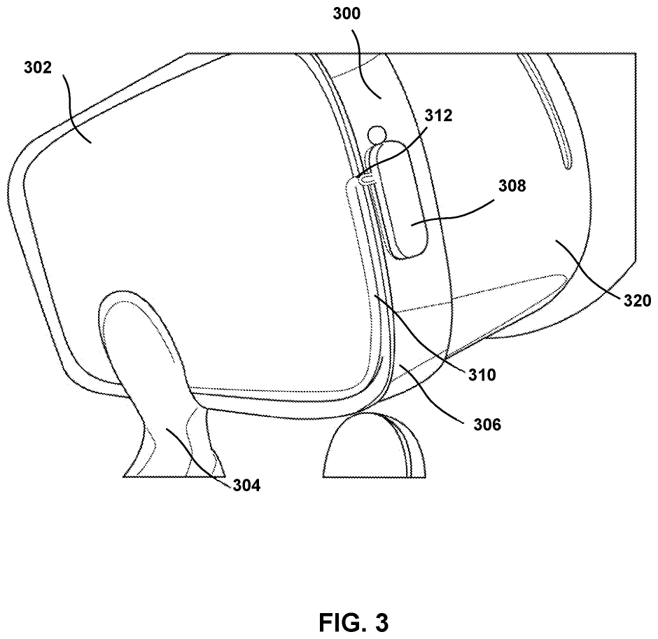

By locating I/O port 208 on the bottom of headset 220, the headset is placed in an aesthetically desirable resting position to charge. This position also prevents users from leaving headset 220 upside down, which could potentially damage headset 220. Additionally, by locating I/O port 208 at this position, power cords (if necessary) may be housed in the cradle or stand, which may prevent the cords from becoming tangled or damaged. As shown in FIG. 3 below, accessory 200 may also include a channel for delivering power, to the power inlet of headset 220 not found on the bottom of headset 220. For example, I/O port 208 may be located at the point of the face plate (e.g., face plate 102 (FIG. 1)) that corresponds substantially to the horizontal center point of the distal end of headset 220.

Additionally, I/O port 208, and its connection to a power outlet, may provide additional stability to the headset 220 while in a resting position. In some embodiments, accessory 200 and/or I/O port 208 are configured to be angled such that the accessory 200 (and headset 220) are angled upward in a direction towards the proximal end of headset 220. The use of this angle provides additional stability to headset 220 while in the resting state. In some embodiments, the upward angle is between 0 and 10 degrees or between 5 and 7 degrees.

FIG. 3 shows an accessory for a virtual reality or augmented reality headset, in which a handle extends from a face plate, in accordance with one or more embodiments. Additionally, accessory 300 includes channel 310, which may allow a cable (e.g., a power cable) to run from a surface feature (e.g., surface feature 308) to an inlet (e.g., I/O port 208 (FIG. 2)) in accessory 300. Channel 310 may open at a first aperture at a first location in face plate 302 or flange 306 and extend to a second aperture (e.g., I/O port 208 (FIG. 2)) at a second location in face plate 302 or flange 306. In some embodiments, the first location may be located near one side of accessory 300 (e.g., near side 112 of headset 120 (FIG. 1)) and the second location may be located at a different side (e.g., a bottom side of accessory 300). For example, channel 310 may begin at aperture 312 and end at an aperture behind handle 304.

Channel 310 may in some embodiments form a hollow tube that extends from one aperture to another. Alternatively channel 310 may be non-continuous along its length. In some embodiments, channel 310 may be open, at least partially, to the interior of accessory 300. For example, a cable extending from one aperture to another could be strung prior to accessory 300 engaging headset 320. After the cable has been strung, accessory 300 may engage headset 320, with the connection of accessory 300 and headset 320 holding the cable in place.

For example, channel 310 may extend through face plate 302 in both a horizontal and vertical direction as shown. Channel 310 may extend through face plate 302 from a first aperture 312 in flange 306 on a first side of the plurality of sides of headset 320 to a second aperture (e.g., I/O port 208 (FIG. 2)) in flange 306 on a second side of the plurality of sides of the headset. Channel 310 extends through face plate 302 and may form a pathway for a cable running from surface feature 308 of headset 320 to an I/O port (e.g., I/O port 208 (FIG. 2)) in face plate 302.

FIG. 4 shows an illustrative range of motion of a removable handle of an accessory, in accordance with one or more embodiments. For example, as shown in FIG. 4, a handle of accessory 400 may be movable to a range of angles (e.g., angles 404). In some embodiments, e.g., if the handle is removable, a user may select the angle upon connecting the handle to accessory 400. As shown in FIG. 4, the downward angle may be between 0 and 89 degrees, between 40 and 50 degrees, or substantially 45 degrees. In some embodiments, angles 404 may be measured from a plane of face plate 402.

In some embodiments, accessory 400 may also provide a range of motion in a horizontal direction. For example, in addition to selecting a downward angle, a user may adjust the handle in a horizontal angle between 0 and 89 degrees, between 40 and 50 degrees, or substantially 45 degrees. The adjustment of the handle in the horizontal direction may provide additional ergonomic benefits to some users. In some embodiments, accessory 400 may include a ball in socket joint or otherwise provide 360 degrees of movement.

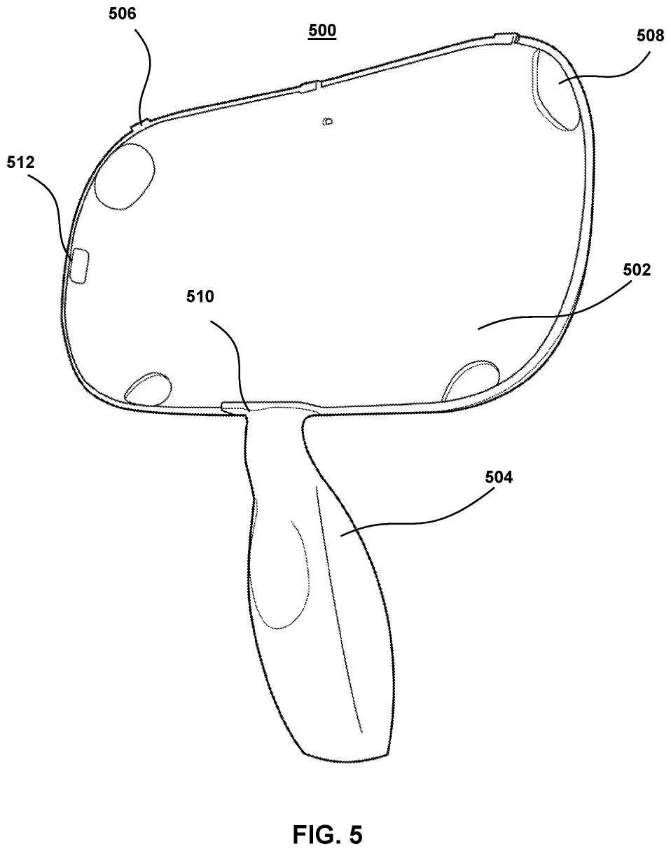

FIG. 5 shows an illustrative face plate, in accordance with one or more embodiments. For example, FIG. 5 shows accessory 500 prior to engagement with a headset. Accessory 500 includes face plate 502 and handle 504. As shown in FIG. 5 handle 504 extends from flange 510. Accessory 500 also includes flange 506. Notably, flange 510 and flange 506 are different sizes.

Accessory 500 also include aperture 508 and aperture 512. These apertures may provide access to surface features and/or prevent obstruction of surface features (e.g., a forward-facing camera on a distal end of a headset.

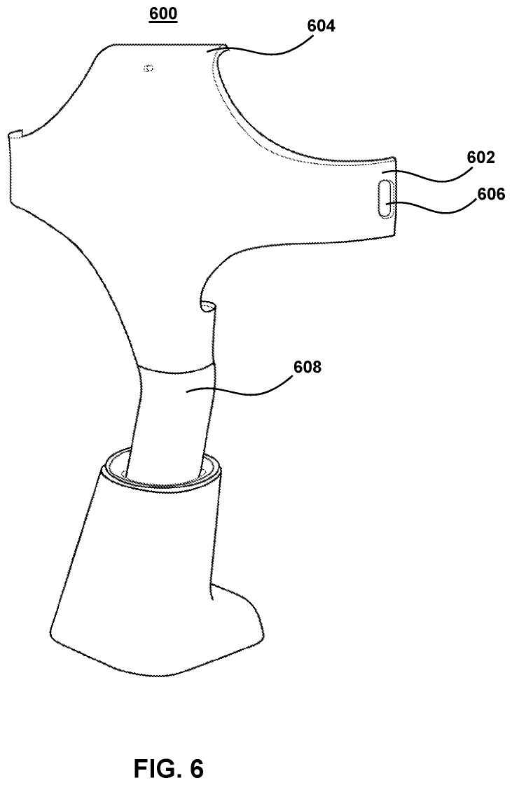

FIG. 6 shows another illustrative face plate, in accordance with one or more embodiments. FIG. 6 shows accessory 600, which is not currently engaged with a headset and is currently engaged with a cradle or stand. In some embodiments, accessory 600 may include an inlet (e.g., I/O port 208 (FIG. 2)), which traverses handle 608. For example, a power connection or battery may be located in handle 608 or may be located at an end distal to accessory 600. Accessory 600 also include flange 602, which include aperture 606. For example, as shown in FIG. 6, accessory 600 comprises a plurality of extensions from a center point of its face plate, in which each extension has a respective flange (e.g., flange 602 or flange 604).

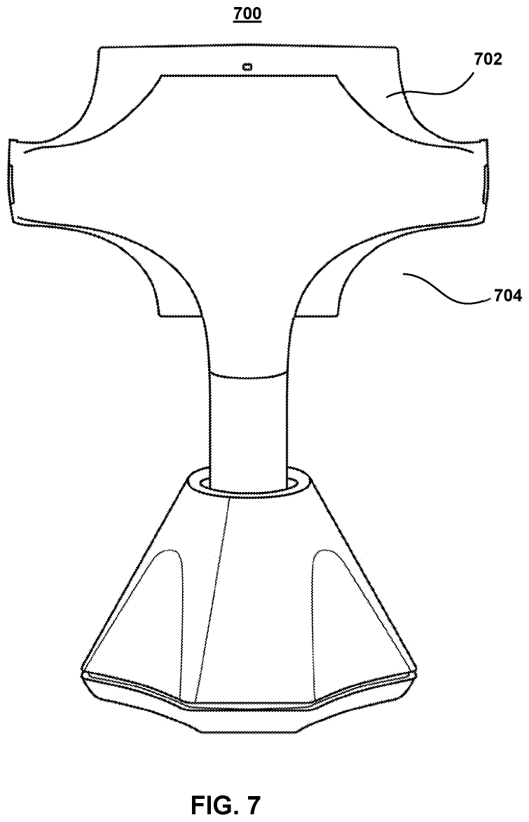

FIG. 7 shows another illustrative face plate, in accordance with one or more embodiments. FIG. 7 shows accessory 700, which is not currently engaged with a headset and is currently engaged with a cradle or stand. As shown in FIG. 7, face plate 702 may include cut-out portion 704. Similar to apertures, cut-out portion 704 may provide access to surface features and/or prevent obstruction of surface features (e.g., a forward-facing camera on a distal end of a headset. For example, face plate 702 includes a cropping (e.g., cut-out portion 704) at a corner of the distal end.

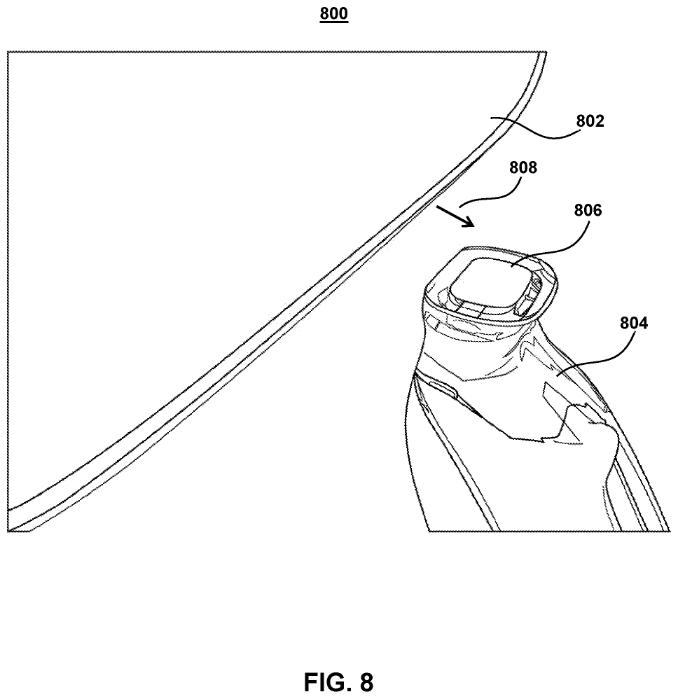

FIG. 8 shows an illustrative accessory with removable handle, in accordance with one or more embodiments. For example, in FIG. 8, accessory 800 may be removably connected to handle 804 by sliding handle 804 in direction 808 (e.g., towards face plate 802). Upon engaging handle 804 and accessory 800, handle 804 may be held by, and/or removably connected to, accessory 800.

Accessory 800 may use a plurality of connection mechanism for engaging and/or holding handle 804. For example, accessory 800, in some embodiments, may rely on friction to hold handle 804. In such embodiments, contacting surfaces of accessory 800 and handle 804 may transmit tangential as well as normal forces across their interfaces. In some embodiments, the normal (contact) forces, may be generated by kinematic constraints or by elastic forces/moments in the connection.

In some embodiments, accessory 800 may rely on magnetic attraction to hold handle 804. For example, in such embodiments, a magnetic force may be exerted by accessory 800 and/or handle 804. For example, a magnet positioned in handle 804 (e.g., at contact 806) may transmit a magnetic force as across its interface with accessory 800. This magnetic force may attract a metallic (e.g., iron or copper-based material) or other magnetically active material located in accessory 800. Alternatively or additionally, a magnet positioned in accessory 800 may transmit a magnetic force as across its interface with handle 804, which may feature a magnetically active material (e.g., at contact 806).

In some embodiments, accessory 800 may rely on a mechanical connection to engage and/or hold handle 804. For example, in some embodiments, accessory 800 may include a snap-fit connection with handle 804. The snap-fit connection may include annular, cantilever, u-shaped, bayonet-finger, and/or torsional snap-fit connections. Furthermore, upon the engagement of handle 804 and accessory 800, handle 804 may be permanently or temporarily connected with accessory 800. Additionally or alternatively, accessory 800 and handle 804 may connect at an I/O port (e.g., I/O port 208 (FIG. 2)). For example, in some embodiments, the engagement of accessory 800 and handle 804 may activate an I/O port that facilitates the transmission of power and/or data. Additionally, the engagement of an I/O port (e.g., situated at contact 806), may itself hold accessory 800 and handle 804 together.

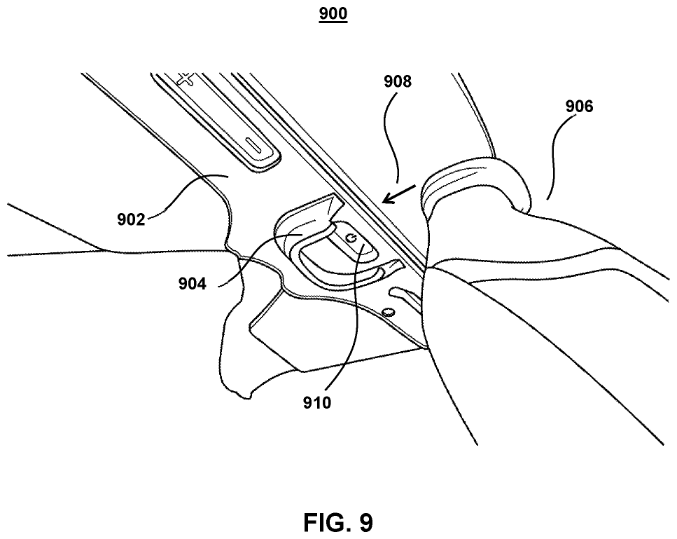

FIG. 9 shows another view of an illustrative accessory with removable handle, in accordance with one or more embodiments. For example, in this view, accessory 900 is viewed from a bottom view. As shown in FIG. 9, connection 904 may be configured to receive handle 906 as handle 906 is moved in direction 908 (e.g., towards accessory 900). In FIG. 9, connection 904 is located on flange 902. It should be noted that in embodiments where a handle (e.g., handle 106 (FIG. 1)) extends from a face plate (e.g., face plate 102 (FIG. 1)) connection 904 may be located on the face plate.

As shown in FIG. 9, connection 904 may be configured to receive handle 906. In some embodiments, connection 904 may rely on friction to hold handle 906. For example, connection 904 may include one or more rigids or other features that elastically deform to hold handle 906. Additionally or alternatively, connection 904 may include may include a snap-fit connection (e.g., annular, cantilever, u-shaped, bayonet-finger, and/or torsional snap-fit connections) with handle 906 and/or any other suitable connection type. In some embodiments, a magnet positioned in connection 904 may transmit a magnetic force as across its interface with handle 906. This magnetic force may attract a metallic (e.g., iron or copper-based material) or other magnetically active material located in handle 906. Alternatively or additionally, a magnet positioned in handle 906 may transmit a magnetic force as across its interface with connection 904, which may feature a magnetically active material. Additionally or alternatively, in some embodiments, the engagement of connection 904 and handle 906 may activate an I/O port that facilitates the transmission of power and/or data. Additionally, the engagement of an I/O port (e.g., situated at connection 904), may itself hold accessory 900 and handle 906 together. In some embodiments, the engagement of handle 906 with connection 904 may cover (or engage) surface feature 910. In some embodiments, surface feature 910 may comprise an I/O port (e.g., I/O port 208 (FIG. 2)).

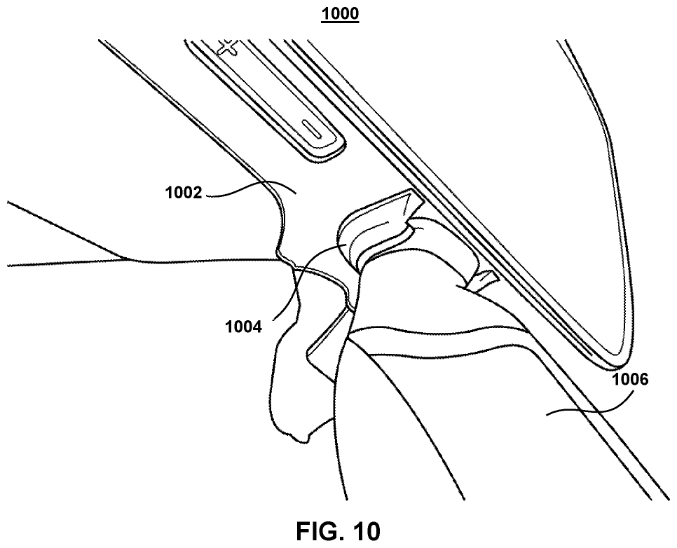

FIG. 10 shows another view of an illustrative accessory with a removable handle engaged will the face plate, in accordance with one or more embodiments. For example, as discussed above in relation to FIGS. 8-9, accessory 1000 may include a removable handle that may be received by accessory 1000. Furthermore, as handle 1006 is received and/or engaged by a connection (e.g., connection 1004) on flange 1002 of accessory 1000, an I/O port (e.g., located at connection 1004 and/or handle 1006) may be activated. In some embodiments, this may initiate a power and/or data transfer to a power source (e.g., battery and/or power cable) and/or data source located in handle 1006. Alternatively or additionally, this may initiate a power and/or data transfer to a cable located in handle 1006 that runs through handle 1006 to another I/O port in handle 1006. For example, handle 1006 may include multiple I/O ports that facilitate power and/or data transfers through it.

For example, handle 1006 may itself connect to a power source (e.g., battery and/or power cable) and/or data source located in a cradle or other device (e.g., as shown in FIGS. 6-7). In such embodiments, handle 1006 may act as a conduit for power and data transfer between accessory 1000 and a cradle, stand, and/or docking stationary. It should also be noted that in some embodiments, a cable may run between handle 1006 and accessory 1000. This cable may include slack in order to facilitate the removal of handle 1006 from accessory 1000. Alternatively or additionally, this cable may be retractable and housed inside accessory 1000 and/or handle 1006 when accessory 1000 and handle 1006 are engaged.

It should also be noted that in some embodiments, a cable (e.g., running through channel 310 (FIG. 3)) may continue through a connection (e.g., connection 904) and on through handle 1006 (e.g., entering at contact 806 (FIG. 8)). The cable may traverse handle 1006 and exit handle 1006 at an I/O port (e.g., I/O port 208 (FIG. 2)). This cable may then continue on to an external power and/or data source. Alternatively, the cable may connect an I/O port (e.g., I/O port 208 (FIG. 2)) that connects to an I/O port (e.g., I/O port 208 (FIG. 2)) on another device. A cable running from a headset (e.g., headset 220 (FIG. 2)), an accessory (e.g., accessory 200 (FIG. 2) (and/or components of accessory 200 (FIG. 2) such as a handle 202 (FIG. 2)), and/or other components (e.g., a cradle or docking station for accessory 200 (FIG. 2)) may additionally provide a security means for the headset, accessory, and/or other components.

In some embodiments, connection 1004 may comprise a hot shoe mounting point. The mounting point may include an angled metal bracket surrounding a metal contact point, which shorts an electrical connection between handle 1006 and accessory 1000. Alternatively, the mounting point may not include an electrical connection and instead be configured to receive handle 1006 and hold it in place. That is, connection 1004 may function as a female shoe to receive handle 1006.

It should also be noted that in some embodiments, connection 1004 may be connected directly to a headset (e.g., headset 120 (FIG. 1)). In such embodiments, connection 1004 may be directly molded onto the headset during fabrication of the headset. Alternatively, connection 1004 may be attached to the headset after fabrication (e.g., via place using plastic solvent glue, over-mold, or epoxy glue). In such embodiments, a handle (e.g., handle 1006) may be attached to a headset (e.g., headset 120 (FIG. 2)) without a face plate (e.g., face plate 102 (FIG. 1)) and/or may connect to the headset without a flange (e.g., flange 204 (FIG. 2)). Additionally or alternatively, other features discussed herein such as channel 310 (FIG. 3)) may be directly incorporated into a headset (e.g., headset 120 (FIG. 1)). That is, handle 1006 may connect to connection 1004, which may be directly connected to a headset (e.g., on the underside of the headset).

The above-described embodiments are presented for purposes of example and not of limitation, and the present disclosure is limited only by the claims which follow. Furthermore, it should be noted that features and limitations described in any one embodiment may be applied to any other embodiment herein, and examples relating to one embodiment may be combined with any other embodiment in a suitable manner.

Additional example embodiments include:
1. An accessory for a virtual reality or augmented reality headset having a proximal end through which a user views content while the headset is in use and a plurality of sides extending from the proximal end to a distal end, the accessory comprising: a face plate removably attached to the headset at the distal end of the headset; a flange extending from the face plate and configured to contact one or more of the plurality of sides of the headset to secure the face plate to the headset; and a handle extending, at a downward angle in the first direction, from a point substantially in line with a horizontal center point of the distal end of the headset.
2. The accessory of embodiment 1, wherein the point is on the face plate or on the flange.
3. The accessory of embodiment 1 or 2, wherein flange is configured to secure the face plate to the headset through elastic deformation.
4. The accessory of any one of embodiments 1-3, wherein the flange includes a protrusion configured to be received by a recess in one or more of the plurality of sides of the headset.
5. The accessory of any one of embodiments 1-4, wherein the flange includes an aperture configured to provide user access to a surface feature on the headset.
6. The accessory of any one of embodiments 1-5, further comprising a channel in the face plate extending in both a horizontal and vertical direction through the face plate.
7. The accessory of any one of embodiments 1-6, further comprising a channel in the face plate extending through the face plate from a first aperture in the flange on a first side of the plurality of sides of the headset to a second aperture in the flange on a second side of the plurality of sides of the headset.
8. The accessory of any one of embodiments 1-7, further comprising a channel in the face plate extending through the face plate and forming a pathway for a cable running from a surface feature of the headset to an I/O port in the face plate.
9. The accessory of any one of embodiments 1-8, further comprising an I/O port in the face plate featuring an electrical contact.
10. The accessory of any one of embodiments 1-9, further comprising an I/O port in the face plate, wherein the I/O port is configured to connect to a cradle when the headset is not in use.
11. The accessory of any one of embodiments 1-10, further comprising an I/O port in the face plate, wherein the I/O port is configured to balance the headset at an upward angle when connected to a cradle.
12. The accessory of embodiment 10, wherein the upward angle is between 0 and 10 degrees or between 5 and 7 degrees.
13. The accessory of any one of embodiments 1-12, further comprising an I/O port at the point of the face plate corresponding substantially to the horizontal center point of the distal end of the headset.
14. The accessory of any one of embodiments 1-13, wherein the point of the face plate from which the handle extends is below a vertical center point of the distal end of the headset.
15. The accessory of any one of embodiments 1-4, wherein the face plate comprises a substantially transparent or opaque material.
16. The accessory of any one of embodiments 1-15, wherein the flange is configured to provide contact with headset about the circumference of the headset.
17. The accessory of any one of embodiments 1-16, wherein the flange is configured to provide non-continuous contact with headset about the circumference of the headset.
18. The accessory of any one of embodiments 1-17, wherein the face plate encapsulates an entirety of the distal end of the headset or encapsulates less than an entirety of the distal end of the headset.
19. The accessory of any one of embodiments 1-18, wherein the face plate comprises a plurality of extensions from a center point of the face plate, and wherein each extension has a respective flange.
20. The accessory of any one of embodiments 1-19, wherein the face plate includes a cropping at a corner of the distal end.
21. The accessory of any one of embodiments 1-20, wherein the downward angle is between 0 and 89 degrees, between 40 and 50 degrees, or is substantially 45 degrees.
22. The accessory of any one of embodiments 1-21, wherein the handle is removable.

1. An accessory for a virtual reality or augmented reality headset having a proximal end through which a user views content while the headset is in use and a plurality of sides extending, in a first direction, from the proximal end to a distal end, the accessory comprising:
a face plate removably attached to the headset at the distal end of the headset;
a flange extending from the face plate and configured to contact one or more of the plurality of sides of the headset to secure the face plate to the headset; and
a handle extending, at a downward angle in the first direction, from a point substantially in line with a horizontal center point of the distal end of the headset.

2. The accessory of claim 1, wherein the point is on the face plate.

3. The accessory of claim 1, wherein the point is on the flange.

4. The accessory of claim 1, wherein flange is configured to secure the face plate to the headset through elastic deformation.

5. The accessory of claim 1, wherein the flange includes a protrusion configured to be received by a recess in one or more of the plurality of sides of the headset.

6. The accessory of claim 1, wherein the flange includes an aperture configured to provide user access to a surface feature on the headset.

7. The accessory of claim 1, further comprising a channel in the face plate extending in both a horizontal and vertical direction through the face plate.

8. The accessory of claim 1, further comprising a channel in the face plate extending through the face plate from a first aperture in the flange on a first side of the plurality of sides of the headset to a second aperture in the flange on a second side of the plurality of sides of the headset.

9. The accessory of claim 1, further comprising a channel in the face plate extending through the face plate and forming a pathway for a cable running from a surface feature of the headset to an I/O port in the face plate.

10. The accessory of claim 1, further comprising an I/O port in the face plate featuring electrical or data transfer contacts.

11. The accessory of claim 1, further comprising an I/O port in the face plate, wherein the I/O port is configured to connect to a cradle when the headset is not in use.

12. The accessory of claim 1, further comprising an I/O port in the face plate, wherein the I/O port is configured to balance the headset at an upward angle when connected to a cradle.

13. The accessory of claim 12, wherein the upward angle is between 0 and 10 degrees.

14. The accessory of claim 12, wherein the upward angle is between 5 and 7 degrees.

15. The accessory of claim 1, further comprising an I/O port at the point of the face plate corresponding substantially to the horizontal center point of the distal end of the headset

16. The accessory of claim 1, wherein the point of the face plate from which the handle extends is below a vertical center point of the distal end of the headset.

17. The accessory of claim 1, wherein the face plate comprises a substantially transparent material.

18. The accessory of claim 1, wherein the flange is configured to provide contact with headset about a circumference of the headset.

19. The accessory of claim 1, wherein the flange is configured to provide non-continuous contact with headset about a circumference of the headset.

20. The accessory of claim 1, wherein the face plate encapsulates an entirety of the distal end of the headset.

21-27. (canceled)
